(19) United States
(12) Patent Application Publication
(10) Pub. No.: US 2001/0050487 A1
(43) Pub. Date: Dec. 13, 2001

(54) Handle and grapple with sliding closure for lifting and carrying elongated objects

(76) Inventor: Gilberto Uridales, Jr., Laredo, TX (US)

Correspondence Address: TED D.LEE, GUNN, LEE & KEELING, 700 N. St. Mary's Street, Suite 1500, San Antonio, TX, 78205, US

(21) Appl. No.: 09/835,508

(22) Filed: Apr. 16, 2001

Related U.S. Application Data
(60) Provisional application No. 60/198,156, filed on Apr. 17, 2000.
(60) Provisional application No. 60/253,042, filed on Nov. 27, 2000.

(51) Int. Cl. B65G 7/12

(52) U.S. Cl. 294/15

(57) ABSTRACT

The present invention provides a grapple with a sliding pin closure for retaining an elongated object within the interior space of the grapple. The sliding pin is preferably biased into engagement with the elongated object under the action of a spring. The grapple is preferably provided with one or more handles for manually lifting and carrying the elongated object. Alternatively, the grapple may be provided with an eyelet or other suitable device for attaching the grapple to a hoist or other lifting machine. The only moving part is the spring-loaded pin, which may be easily removed for maintenance. Although this invention is intended primarily for use in lifting and carrying oil field pipe, this invention may also be used to advantage with other elongated objects, such as fire hoses.

### CROSS-REFERENCE TO RELATED APPLICATIONS

This application claims priority from United States Provisional Patent Application Ser. No. 60/198,156 filed Apr. 17, 2000, and United States Provisional Patent Application Ser. No. 60/253,042 filed Nov. 27, 2000.

### BACKGROUND OF THE INVENTION

1. Field of the Invention

The present invention relates generally to devices for lifting and carrying elongated objects such as pipes and hoses.

2. Description of the Related Art

In oil field operations, it is frequently necessary to manually lift and carry oil field pipe or frac pipe. Similarly, in firefighting operations, fire hoses must be lifted and carried by hand. Typically, such pipes and hoses must be handled under wet and slippery conditions, which are generally hazardous to the personnel involved. Additionally, such pipes and hoses are generally quite heavy and difficult to handle, even under dry conditions, which causes physical fatigue in the personnel involved.

U.S. Pat. No. 5,024,476, issued to Massey on Jun. 18, 1991, discloses a tool for assisting in manually raising a heavy elongated article a small distance (e.g., a few inches) off a firm surface so that a lifting sling may be passed beneath the article. The Massey tool comprises a handle having a pair of co-acting, part-cylindrical jaw members that operate in a scissor-like manner for gripping the article to be raised, and a fulcrum projects from one of the jaw members on which the tool can be pivoted to raise the article a short distance off the surface. Although the Massey tool is capable of raising heavy elongated objects such as oil field pipe a few inches off the deck, the Massey tool is not suitable for carrying such pipe after it has been lifted off the deck.

U.S. Pat. No. 5,791,704, issued to Thompson et al. on Aug. 11, 1998, discloses a tool for manipulating irrigation pipes. The Thompson et al. tool involves a pivotally mounted arcuate jaw with a handle secured thereto, and a second arcuate jaw fixedly mounted to the handle. A spring biases the jaw members into clamping engagement with an irrigation pipe. The Thompson et al. tool is directed primarily to turning, connecting, and disconnecting irrigation pipe without the operator having to bend over and grasp the pipe by hand. However, like the Massey tool described above, the Thompson et al. tool is not suitable for carrying such pipe.

Thus, a need exists for a tool that would allow personnel to easily grasp, lift, and carry pipes, hoses, and other elongated objects, particularly under wet and slippery conditions. Such a tool would increase safety and decrease physical fatigue of pipe handling personnel. Such a tool should be simple to use, inexpensive to manufacture, and easy to maintain.

### SUMMARY OF THE INVENTION

It is therefore an object of the present invention to provide a simple and reliable device for lifting and carrying elongated objects such as pipes and hoses.

It is a further object of the present invention to provide a device for safely lifting and carrying elongated objects under slippery and wet conditions.

It is still another object of this invention to provide a device that reduces physical fatigue in the process of lifting and carrying heavy elongated objects.

It is yet another object of the present invention to provide a simple mechanical device for lifting and carrying elongated objects that is easy to maintain.

In fulfillment of these and other objectives, the present invention provides a grapple with a sliding pin closure for retaining an elongated object within the interior space of the grapple. The sliding pin is preferably biased into engagement with the elongated object under the action of a spring. The grapple is preferably provided with one or more handles for manually lifting and carrying the elongated object. Alternatively, the grapple may be provided with an eyelet or other suitable device for attaching the grapple to a hoist or other lifting machine. The only moving part is the spring-loaded pin, which may be easily removed for maintenance. The present invention is intended primarily for use in lifting and carrying oil field pipe, but this invention may also be used in connection with other elongated objects.

### BRIEF DESCRIPTION OF THE DRAWINGS

FIG. 1 is an exploded perspective view of a tool in accordance with the present invention.

FIG. 2 is a rear elevational view of the tool of FIG. 1.

FIG. 3 is a side elevational view of the tool of FIG. 1.

FIG. 4 is a view looking in the direction of arrows 4-4 of FIG. 1.

FIG. 5 is a perspective view of an alternative tool in accordance with the present invention.

FIG. 6 is a side elevational view of the tool of FIG. 5.

FIG. 7 is an exploded view of the sliding rod assembly of FIGS. 5 and 6.

FIG. 8 is a perspective view of another alternative tool in accordance with the present invention.

FIG. 9 is a side elevational view of the tool of FIG. 8.

FIG. 10 is a rear elevational view of yet another alternative tool in accordance with the present invention.

FIG. 11 is a side elevational view of the tool of FIG. 10.

### DETAILED DESCRIPTION OF THE PREFERRED EMBODIMENTS

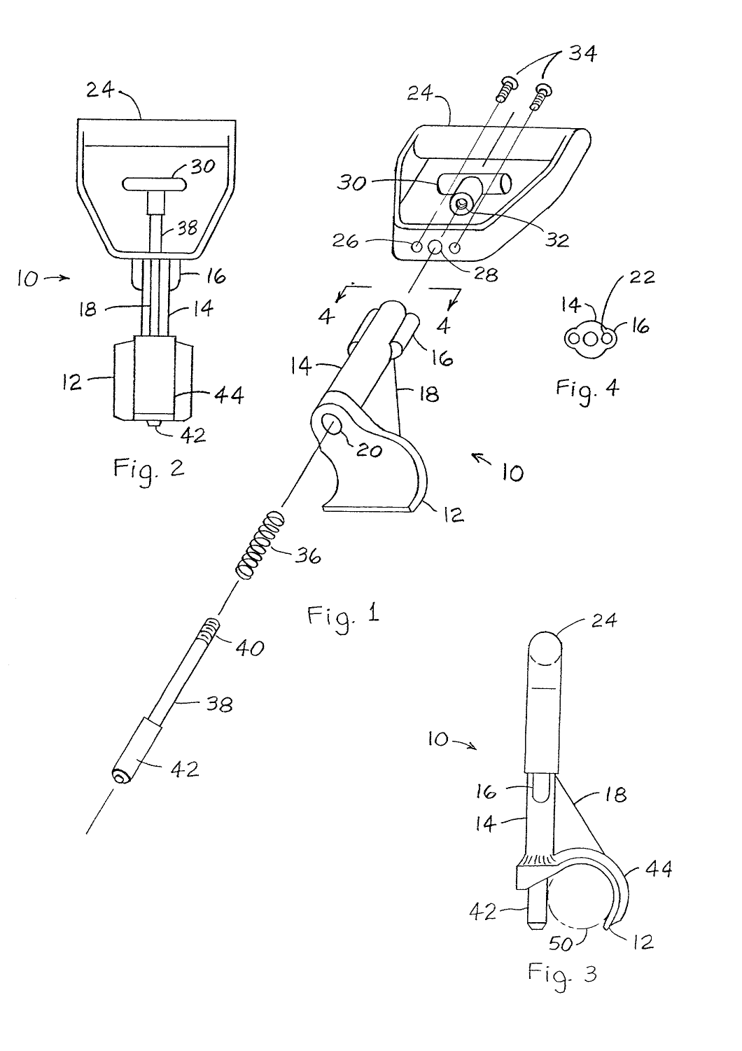

Referring to FIGS. 1-4, a tool 10 in accordance with the present invention comprises a grapple 12 for engaging an elongated object such as pipe 50. A cylinder 14 is connected to grapple 12, which is preferably reinforced with a stiffener 44 that may be integral to grapple 12. A gusset 18 may be fastened to cylinder 14 and stiffener 44 to provide increased stiffness and strength. Grapple 12 has a hole 20 aligned with cylinder 14, which houses shank 38 of a sliding pin 42 that serves to retain pipe 50 in engagement with the interior surface of grapple 12. Pin 42 is preferably biased into the engaged position (shown in FIG. 3) with a biasing element, such as spring 36. Cylinder 14 preferably comprises a pair of bosses 16 having tapped holes 22 for attaching a handle 24 to cylinder 14 with screws 34 through matching holes 26 in handle 24. A pin handle 30 is provided with a tapped hole 32, which cooperates with threads 40 on shank 38 for attaching pin handle 30 to pin 42. Shank 38 protrudes through hole 28 in handle 24. When pin handle 30 is pulled with sufficient force to overcome spring 36, pin 42 is retracted into cylinder 14 and pipe 50 is thereby released from grapple 12. Pin 42 may be retracted in the same manner in order to insert a pipe 50 into grapple 12.

It will be understood that although this description refers to a pipe 50 to illustrate the use of the present invention, other elongated objects, such as solid shafts or fire hoses, may also be handled with the present invention. Preferably, for handling pipes or other cylindrical objects, grapple 12 generally has a circular curvature to match the outer diameter of the object being handled. However, for handling elongated objects having non-cylindrical cross-sectional shapes, grapple 12 may also be non-cylindrical. For example, grapple 12 may comprise one or more flat interior surfaces, such as the surfaces of a partial hexagon for grasping objects having hexagonal cross-sections. Additionally, the cross-sectional shape of grapple 12 may be non-uniform, depending on the objects to be lifted. For example, the cross-sectional shape of grapple 12 may comprise a series of different curvatures. Accordingly, as used herein, the term “grapple” means any structure having an open, non-planar cross-sectional shape that is capable of receiving an elongated object in its interior space.

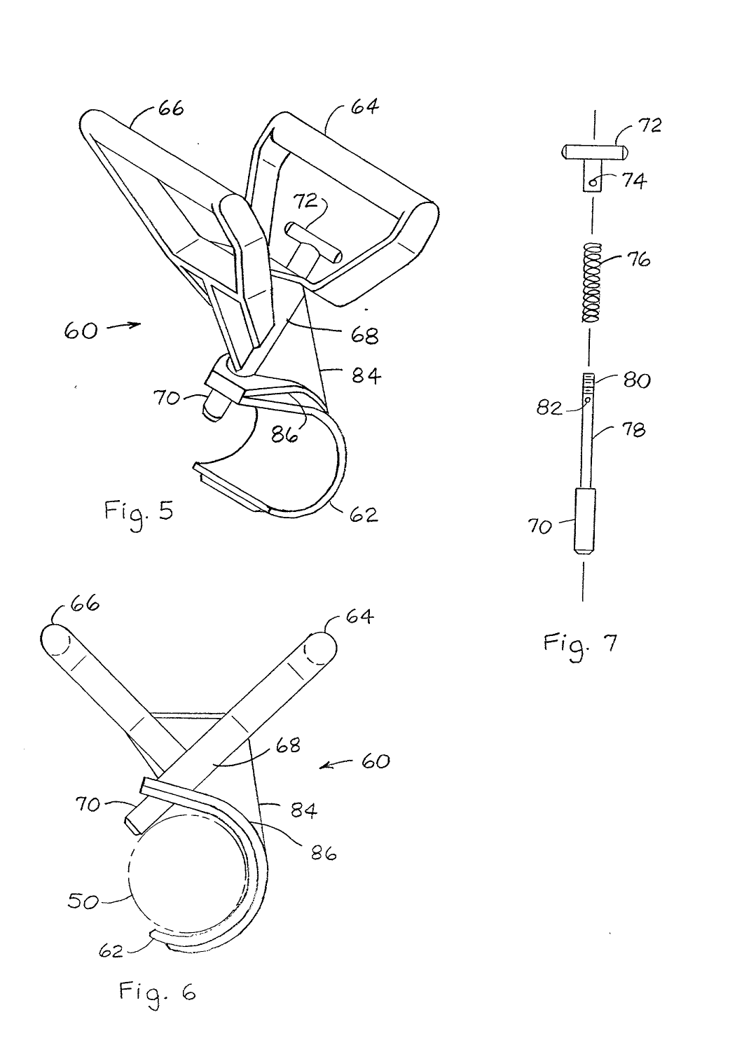

FIGS. 5 and 6 illustrate another tool 60 in accordance with the present invention. Like tool 10 described above, tool 60 comprises a curved grapple 62 and a sliding pin 70 housed within a cylinder 68 for grasping an elongated object such as pipe 50. Tool 60 has two handles 64 and 66 depending from cylinder 68. Handles 64 and 66 are substantially parallel to each other. This two-handled tool 60 is especially useful for lifting and carrying heavy objects that require two people for safe handling, with one person holding handle 64 and another person holding handle 66. Preferably, a stiffener 86 is provided on grapple 62, and stiffener 86 may be integral to grapple 62. A gusset 84 is preferably attached to cylinder 68 and stiffener 86 for enhanced strength and stiffness. A pin handle 72 is provided for retracting pin 70 into cylinder 68. As shown in FIG. 7, like pin 42 of tool 10 described above, pin 70 has a shank 78 with threads 80 for screwing pin 70 into a tapped hole (not shown) in pin handle 72. Additionally, as an extra safety feature, a pair of cooperating holes 74 and 82 on pin handle 72 and shank 78, respectively, may be provided for receiving a locking pin (not shown). A spring 76 is installed over shank 78 to bias pin 70 into the engaged position shown in FIG. 6. To release pipe 50 from grapple 62, pin handle 72 must be pulled with sufficient force to overcome spring 76 so that pin 70 is retracted into cylinder 68. Pin 70 is retracted in the same manner in order to initially insert pipe 50 into grapple 62.

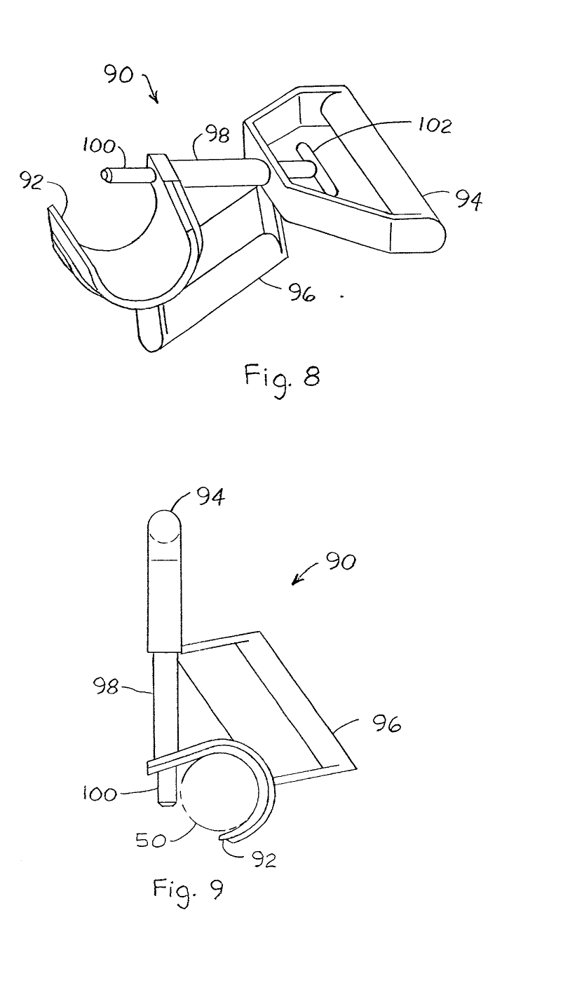

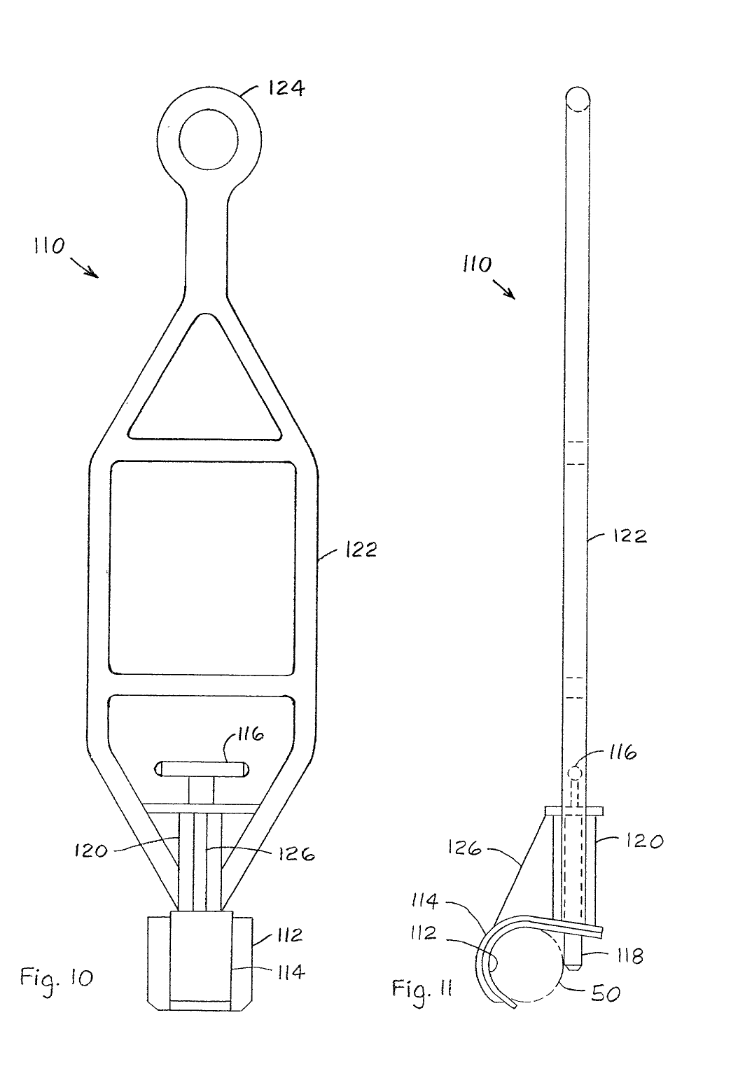

FIGS. 8 and 9 illustrate another two-handled tool 90 intended primarily for use by one person to lift relatively light objects and place them on racks at elevations that may be shoulder level or higher. Like the other tools described above, tool 90 comprises a curved grapple 92 and a sliding pin 100 housed within a cylinder 98 for grasping an elongated object such as pipe 50. Tool 90 has one handle 94 oriented basically perpendicular to cylinder 98 and another handle 96 oriented transverse to handle 94. A user would grasp handle 94 with one hand and handle 96 with the other hand. Pin 100 is preferably spring loaded and operated by pin handle 102 in the same manner as pins 42 and 70 described above in connection with tools 10 and 60, respectively.

FIGS. 10 and 11 illustrate yet another tool 110 that has an eyelet 124 for attachment to a hoist or other lifting machine (not shown). Tool 110 has a grapple 112 with a stiffener 114 attached to a cylinder 120 that houses a spring-loaded sliding pin 118, which is operated by pin handle 116 in like manner as discussed above in connection with tools 10, 60, and 90. Preferably, a gusset 126 is attached between cylinder 120 and stiffener 114 for increased stiffness and strength. Like tools 10, 60, and 90 described above, grapple 112 and pin 118 cooperate to grasp an elongated object such as pipe 50 for lifting and carrying the same. The grapple and pin assembly is attached to a frame 122 with eyelet 124 at the top. By attaching tool 110 to a hoist or other lifting machine using eyelet 124 or other suitable connection, heavier objects may be lifted and moved more easily than by hand.

It will be apparent to those skilled in the art that the handles of tools 10, 60, and 90 and the eyelet of tool 110 constitute just a few examples of a variety of structures that may be utilized to apply a lifting force to the particular tool once an elongated object is secured in the tool's grapple with the spring-loaded sliding pin. Accordingly, any such device that may be used to apply a lifting force to the tool is referred to herein as a “lifting connection.”

Although the foregoing specific details describe preferred embodiments of this invention, persons reasonably skilled in the art will recognize that various changes may be made in the details of this invention without departing from the spirit and scope of the invention as defined in the appended claims. Therefore, it should be understood that this invention is not to be limited to the specific details shown and described herein.

We claim:

1. A tool for grasping and lifting an elongated object, said tool comprising:
a grapple having an interior space capable of receiving the elongated object;
a pin slidably mounted to said grapple, said pin being capable of protruding into said interior space of said grapple and retaining the elongated object in engagement with said grapple; and
a lifting connection depending from said grapple.

2. The tool of claim 1 wherein said grapple comprises at least one curved interior surface.

3. The tool of claim 1 further comprising a biasing element for biasing said pin toward a position of engagement with the elongated object.

4. The tool of claim 3 wherein said biasing element comprises a spring.

5. The tool of claim 1 wherein said lifting connection comprises at least one handle.

6. The tool of claim 5 wherein said at least one handle comprises two handles.

7. The tool of claim 6 wherein said two handles are substantially parallel to each other.

8. The tool of claim 6 wherein said two handles are substantially transverse to each other.

9. The tool of claim 1 wherein said lifting connection comprises an eyelet.
